(19) United States
(12) Patent Application Publication
(10) Pub. No.: US 2025/0121287 A1
(43) Pub. Date: Apr. 17, 2025

(54) Interactive Game Rooms

(71) Applicant: Alexander B. Patterson, Brooklyn, NY (US)

(72) Inventor: Alexander B. Patterson, Brooklyn, NY (US)

(21) Appl. No.: 18/913,867

(22) Filed: Oct. 11, 2024

Related U.S. Application Data
(60) Provisional application No. 63/543,892, filed on Oct. 12, 2023.
(60) Provisional application No. 63/543,697, filed on Oct. 11, 2023.
(60) Provisional application No. 63/543,902, filed on Oct. 12, 2023.
(60) Provisional application No. 63/590,362, filed on Oct. 13, 2023.
(60) Provisional application No. 63/590,371, filed on Oct. 13, 2023.

(51) Int. Cl. A63F 13/65; A63F 13/235; A63F 13/27; A63F 13/327; A63F 13/79

(52) U.S. Cl. CPC A63F 13/65; A63F 13/235; A63F 13/27; A63F 13/327; A63F 13/79

(57) ABSTRACT

Interactive game rooms are described herein that utilize advanced technology to create a dynamic, personalized gaming experience by integrating wireless communication devices, various game screens, and other various interactive devices. Players are assigned wireless communication wearable devices that can transmit unique identification data, allowing for tracking their movements and interactions in real time. A game logic associated with the interactive game room can process this data to adjust game modes, display personalized content on a game screen, and control access to different areas or game features. Wireless communication devices and sensors may continuously monitor player activity, enabling responsive gameplay and ensuring that all interactions are accurately logged and authenticated. Interactive devices, such as touchscreens and wireless sensors, and the like, can provide immersive experiences, dynamically reacting to player actions and enhancing engagement. This integrated approach can ensure that each player's experience is uniquely tailored to their preferences and skill level.

### PRIORITY

This application claims the benefit of and priority to U.S. Provisional Application, entitled “Interactive Wireless Reader,” filed on Oct. 12, 2023 and having application Ser. No. 63/543,892; U.S. Provisional Application entitled “Integrated Display and Wireless Reader Interactive Device”, filed Oct. 12, 2023 and having application Ser. No. 63/543,697; U.S. Provisional Application entitled “4-Walled Interactive Game Room”, filed Oct. 12, 2023 and having application Ser. No. 63/543,902; U.S. Provisional Application entitled “Three-Walled Interactive Game Bay”, filed Oct. 13, 2023 and having application Ser. No. 63/590,362, and U.S. Provisional Application entitled “Methods and Systems for Interactive Gaming with Mobile Game Units”, filed Oct. 13, 2023 and having application Ser. No. 63/590,371, the entirety of said application being incorporated herein by reference.

### FIELD

The present disclosure relates to interactive gaming. More particularly, the present disclosure relates to various interactive game rooms with one or more interactive elements.

### BACKGROUND

Previous approaches to wireless readers have typically involved separate components and limited functionality. Conventional wireless readers have consisted of a case housing various components, including a processor, a wireless sensor, illumination devices, and a communication port. These components have been individually integrated into the case, but have not been effectively combined to provide a comprehensive solution.

In some existing wireless readers, the case serves as a protective housing for the internal components. The processor is responsible for executing instructions and controlling the operation of the wireless reader. The wireless sensor is used to detect and capture wireless signals, enabling communication with external devices. Illumination devices are incorporated to provide adequate lighting for scanning or reading purposes. The communication port allows for data transfer between the wireless reader and external devices, such as computers or mobile devices. However, these conventional wireless readers have lacked integration and coordination between these components, resulting in limited functionality and efficiency.

Other approaches have attempted to incorporate game logic into wireless readers, allowing for interactive and gamified experiences. These wireless readers have included a communication port that is coupled to game logic, enabling the wireless reader to interact with gaming systems or applications. However, these previous approaches have not fully integrated the game logic with the other components of the wireless reader, resulting in limited synchronization and compatibility.

In summary, previous approaches to wireless readers have involved separate components housed within a case, including a processor, a wireless sensor, illumination devices, and a communication port. While some attempts have been made to incorporate game logic into wireless readers, these approaches have not provided a comprehensive solution that combines all of these features in an integrated and synchronized manner.

### SUMMARY OF THE DISCLOSURE

Systems and methods for a four-walled interactive game room with interactive elements in accordance with embodiments of the disclosure are described herein. In some embodiments, an interactive game bay includes a processor, a plurality of interactive game bay devices, a projector configured to display images related to an interactive game, a memory communicatively coupled to the processor, wherein the memory includes a game bay logic. The logic is configured to establish communication with the plurality of interactive game bay devices, initialize the interactive game, wherein the interactive game is configured to utilize the plurality of interactive game bay devices and projector, generate game data associated with a plurality of players, wherein: each of the plurality of players is associated with a wireless communication device, and each wireless communication device is configured to transmit identification data, receive identification data via at least one of the interactive game bay devices, process the identification data, and adjust at least one attribute of the interactive game in response to the processed identification data.

In some embodiments, each of the plurality of interactive game bay devices includes at least a display and a wireless transceiver unit.

In some embodiments, the identification data is transmitted to the wireless transceiver unit

In some embodiments, the wireless transceiver unit is a radio frequency identification (RFID) transceiver.

In some embodiments, the game bay logic is further configured to direct the projector to indicate the adjustment of the at least one attribute.

In some embodiments, the game bay logic is further configured to direct the at least one of the plurality of interactive game bay devices to indicate the adjustment of the at least one attribute.

In some embodiments, the interactive game bay further includes four walls, wherein two of the walls are configured with at least one interactive game bay device.

In some embodiments, at least one of the walls is configured with a screen configured to receive images displayed by the projector.

In some embodiments, at least one of the walls is configured with a doorway for entering the interactive game bay.

In some embodiments, at least one of the walls is configured with a doorway for entering a second interactive game bay.

In some embodiments, the interactive game bay further includes three walls, wherein one of the walls are configured with at least two interactive game bay devices.

In some embodiments, at least one of the walls is configured with a screen configured to receive images displayed by the projector.

In some embodiments, one wall is a shared wall with a second interactive game bay.

In some embodiments, processing the identification data includes comparing at least a portion of the identification data against a player value associated with the interactive game.

In some embodiments, the player value is associated with a specific player.

In some embodiments, the attribute of the interactive game is associated to whether a certain player interacted with at least one of the plurality of interactive game bay devices.

In some embodiments, an interactive game bay includes at least three walls, a plurality of interactive game bay devices wherein each of the plurality of interactive game bay devices are mounted at the same height relative to a floor on at least one of the three walls, a projector configured to display images related to an interactive game on at least one of the three walls, an interactive gaming device, including: a processor, a memory communicatively coupled to the processor, wherein the memory includes a game bay logic. The logic is configured to establish communication with the plurality of interactive game bay devices, initialize the interactive game, wherein the interactive game is configured to utilize the plurality of interactive game bay devices and projector, generate game data associated with a plurality of players, wherein: each of the plurality of players is associated with a wireless communication device, and each wireless communication device is configured to transmit unique identification data, receive identification data via at least one of the interactive game bay devices, process the identification data, and adjust at least one attribute of the interactive game in response to the processed identification data.

In some embodiments, the interactive game bay includes four walls and the plurality of interactive game bay devices are mounted on at least two of the four walls.

In some embodiments, the unique identification data is assigned to a specific player of the plurality of players.

In some embodiments, a method of conducting an interactive game within an interactive game room includes establishing communication with a plurality of interactive game bay devices and a projector, initializing the interactive game, wherein the interactive game is configured to utilize the plurality of interactive game bay devices and projector, generating game data associated with a plurality of players, wherein each of the plurality of players is associated with a wireless communication device, and each wireless communication device is configured to transmit identification data, receiving identification data via at least one of the interactive game bay devices, processing the identification data, and adjusting at least one attribute of the interactive game in response to the processed identification data.

In some embodiments, a wireless reader, includes a case; a processor; a wireless sensor; a plurality of illumination devices; a communication port, wherein the communication port is coupled to a game logic.

In some embodiments, the case is composed of plastic.

In some embodiments, the case includes two interlocking portions disposed along an interlocking plane.

In some embodiments, the first interlocking portion is included of clear plastic suitable for wireless signal transmission.

In some embodiments, the plurality of illumination devices are disposed within the case.

In some embodiments, the plurality of illumination devices are light-emitting diodes.

In some embodiments, the light-emitting diodes are configurable between a plurality of different colors.

In some embodiments, a selection of a color from the plurality of different colors is based on a current game state associated with the game logic.

In some embodiments, the wireless reader further includes a haptic motor.

In some embodiments, the engagement of the haptic motor is in response to a current game state associated with the game logic.

In some embodiments, the wireless sensor is a radio-frequency identification (RFID) sensor.

In some embodiments, the RFID sensor is configured to read data from a wearable device.

In some embodiments, the wearable device is a wristband.

In some embodiments, the RFID sensor is configured to capture data from the wristband upon placing the wristband against a portion of the game case.

In some embodiments, capturing data from the wristband triggers a communication via the communication port to the game logic.

In some embodiments, the communication is configured to elicit a change in the current game state.

In some embodiments, at least one of the plurality of illumination devices is directed to change a state in response to the change in the current game state.

In some embodiments, a haptic motor is engaged in response to the change in the current game state.

In some embodiments, the processor is associated with a microcontroller system.

In some embodiments, the communication port is an ethernet port.

In some embodiments, the communication port is a wireless networking device.

In some embodiments, the wireless networking device is a Wi-Fi device.

In some embodiments, the wireless networking device is a Bluetooth device.

In some embodiments, the wireless reader is in wireless communication with a plurality of additional wireless readers.

In some embodiments, an interactive game display system includes a wireless reader including: a case; a processor; a display driver; a wireless sensor; a plurality of illumination devices; and a communication port, wherein the communication port is coupled to a game logic; and a display, including a display driver adapter; wherein the display driver is configured to interact with the display driver adapter to communicate display information to the display; and the display information is configured to display one or more current game states associated with the game logic.

In some embodiments, the one or more current game states is associated with a color assigned to a particular player.

In some embodiments, the display information and the plurality of illumination devices are configured to display a similar color assigned to the particular player.

In some embodiments, a player can interact with the wireless sensor with a wearable device.

In some embodiments, the wearable device is a wristband.

In some embodiments, the proximity of the wireless reader in relation to the display allow for installation of the display at a first height, and the installation of the wireless reader at a second height.

In some embodiments, the first height is greater than the second height.

In some embodiments, the first height is at an eye level.

In some embodiments, the display information is configured to display a player's name that is required to interact with the wireless reader.

In some embodiments, the selection of the player's name is based on a current game state associated with the game logic.

In some embodiments, an interactive gaming room includes an enclosed area; a main display disposed on a first side; a plurality of displays; a plurality of wireless readers; a sound system; a plurality of illumination devices; and a first doorway.

In some embodiments, the display is a screen configured for use by a projector.

In some embodiments, the interactive game room further includes a second doorway.

In some embodiments, the plurality of illumination devices are configured to be light-emitting diodes.

In some embodiments, the light-emitting diodes are disposed along the lower half of the interactive game room.

In some embodiments, the plurality of displays are disposed on each wall such that two displays are on each wall with the exception of the wall disposed with the main display.

In some embodiments, each display is disposed at a uniform height from the floor.

In some embodiments, the two displays on each wall are disposed at a distance apart sufficient to allow for a doorway to be installed.

In some embodiments, a wireless reader is disposed under each display at a uniform distance.

In some embodiments, each wireless reader is disposed at a uniform height from the floor.

In some embodiments, the wall with the main display further includes two wireless readers disposed at the uniform height above the floor.

In some embodiments, the two wireless readers disposed on the wall with the main display are disposed such that they are symmetrical on a vertical plane with the wireless readers disposed on the opposing wall.

In some embodiments, the plurality of displays are touchscreen displays.

In some embodiments, the main display, the plurality of displays, the plurality of wireless readers, the sound system, and the plurality of illumination devices are in communication with a game logic.

In some embodiments, the main display and the plurality of displays are configured to display interactive game elements associated with a game.

In some embodiments, the wireless readers and the plurality of illumination devices are configured to change color in response to a change in a game state associated with the game logic.

In some embodiments, the change in a game state is associated with input received from the touchscreen displays.

In some embodiments, the change in a game state is associated with input received from the plurality of wireless readers.

In some embodiments, game room is configured in a square shape with equal-sized walls.

In some embodiments, each or the equal-sized walls is configured with a width of approximately ten feet.

In some embodiments, each or the equal-sized walls is configured with a width of approximately three meters.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1A is a first wall type for an interactive game room in accordance with various embodiments of the disclosure;

FIG. 1B is a second wall type for an interactive game room in accordance with various embodiments of the disclosure;

FIG. 1C is a third wall type for an interactive game room in accordance with various embodiments of the disclosure;

FIG. 1D is a fourth wall type for an interactive game room in accordance with various embodiments of the disclosure;

FIG. 2 is a conceptual illustration of a plurality of players engaging in a game with multiple interactive game room devices in accordance with various embodiments of the disclosure;

FIG. 3 is a conceptual illustration of a multi-bay interactive game room in accordance with various embodiments of the disclosure;

FIG. 4 is a conceptual illustration of a plurality of interactive game rooms in accordance with various embodiments of the disclosure;

FIG. 5 is a conceptual illustration of a plurality of players utilizing an interactive game room in accordance with various embodiments of the disclosure;

FIG. 6 is a conceptual block diagram of a device suitable for configuration with a game logic in accordance with various embodiments of the disclosure;

FIG. 7 is a flowchart depicting a process for executing a game within an interactive game room in accordance with various embodiments of the disclosure;

FIG. 8 is a flowchart depicting a process for utilizing an interactive game room device within the interactive game room in accordance with various embodiments of the disclosure; and

FIG. 9 is a flowchart depicting a process for executing a game within a multi-bay interactive game room in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that provide for an interactive game room that can be reconfigured to different games and/or different teams. The games can be played through a series of interactions. These interactions can allow for changes in game states within a logic, such as, but not limited to, a game logic. The combination display and wireless readers can be disposed in an interactive gaming area for use in one or more games by various players.

The use of an RFID reader in an active gaming situation can occur in various embodiments. It was identified that a problem of how to ensure that all players on a team had crossed a laser maze to the other side of the room existed. If you used a normal arcade button, or even many of them, it would be possible for a team of many players to only send one or two players across, who could then press all of the buttons for the entire team. Thus, having players on both sides of the room, the team could “advance” the levels of the laser maze by alternately pushing buttons on one side, and then the other. To solve this, many embodiments utilize a wireless communication device that can be wearable by a player, such as an RFID wristband on each player, along with an RFID reader/sensor on each side of the room.

In some embodiments, it is desirable to be able to know who was wearing which wristband. In this way, a game logic or administrator could know just how fast it took each player to get across the laser maze. It could be known that a first player took seventeen seconds, a second player took nineteen seconds, a third player took twenty-three seconds, and a fourth player held up the rear at thirty seconds. Data could be received for each crossing, i.e., level, and then average your times across all the levels. The system could compare data by various player data, such as player age, gender, by location, by time of day, etc.

Subsequently, as various games within the interactive game room may benefit from having individualized wireless communication (such as RFID) readers mapped to each person's name and profile, some embodiments include an onboarding system. In certain embodiments, the system would require a player to type in a player's name into a computer, and during a process of wearable device assignment, the system would assign a wearable such as a wristband to that name and then provide it to the player. The system can then do this for as many players as necessary for the given game. In some embodiments, a more sophisticated game logic or system may allow tablet or other mobile computing devices can allow players to sign waivers with all of their required information. That information can get pulled into a database or other game logic. In additional embodiments, the system can assign a wristband to a player's full profile (reservation, name, email, phone number, age, etc.), and even go further to group players into teams. Various interactive games now can use wristbands to collect a variety of data on our players' performance in the games, which can be transferred or registered via the wireless readers.

In more embodiments, the wireless readers can be utilized as a “check-in” system using RFIDs or other wireless devices and/or protocols. In this way, once a team entered the room, they would, for example, tap an RFID reader/sensor and the game would start. That would mean additional employees are not needed for watching each room at all times within the interactive game rooms. The players can move themselves along after the end or a game or a predetermined period of time from one room to the next, and tap, for example, one or more RFID readers to activate their next game. In further embodiments, with a concept of a reprogrammable interactive game room, where the games could change but be played on the same technology, that we could program a player's experience in our interactive game logic system, and “key” it with the players on the teams' RFID wristbands, so that when a “Team X” programmed for “Game Set A” tapped in via the wireless reader, the interactive game room could play the relevant game from “Game Set A”, but when a “Team Y” programmed for “Game Set B” tapped in via the wireless reader(s), the room would play the relevant game for that room from “Game Set B”.

The interactive game room is a new standard in the developing genre/field of interactive digital gaming. Featuring various layouts including one with eight wireless communication devices like RFIDs disposed in an equidistant fashion around the walls, some of which are part of an Integrated RFID and Touch Screen Units (i.e., displays), with a projection front wall, and integrated sound, and integrated LED baseboard lighting. The room can be powered by a plurality of computers operating a game logic or equivalent in a cabinet with a fan, either inside or outside the room (or even remotely). The interactive game room devices and other components can all be networked, all communicating through a server using a common messaging protocol. In some embodiments, games can involve multiple players with identifying RFID wristbands undertaking a variety of interactions, such as movement and tapping RFIDs of different colors, passing information and instructions from touch screen to touch screen, flinging shapes from one screen through negative space to another screen, tapping and “loading” the wristband with information and carrying it to another Integrated RFID and screen, pattern recognition of shapes identified on the main front projection wall with use of the Integrated RFID Unit and Screens as input devices for replay of patterns or answering of questions.

In a number of embodiments, interactive game rooms can have an input device, such as but not limited to, a USB mini-keyboard wall holder/mount inside the room for game technicians to be able to easily access the keyboard to be able to access a menu and start, stop, advance, rewind game levels and other controls. The rooms' technology architecture and spacing, can have the interactive game room devices (displays or display and wireless transceiver combination units) placed equidistant at a given number of feet off of the floor and from the corners in a room, such as a square ten foot by ten foot room (four wall square room format), with a five foot distance from the centerline, allowing therefore the proper width for a central door on each of its three sides that are not a projection-wall side. This can allow for seamless end-to-end daisy chain placement of multiple rooms in a row down a hallway, such that players can move from interior or one room to interior of another room, without accessing a hallway. (While also allowing a hallway to be outside of all rooms in a linear way, with doors into each room as well). In some embodiments, the interactive game room can be configured in a ten foot by twenty-foot format (four wall rectangular format) room which can also be designed with a door also in the same (corresponding) place on one of its ten foot walls, to allow the two room formats to link perfectly next to each other. In some embodiments, half lite doors can be used so that technicians or spectators walking in outside hallways can look into the game rooms and see their screens and the participants inside.

These four-wall square room formats can also have an additional interactive game room unit outside of the room, on the wall, next to the door (located, for example, on the handle-side of the door). That exterior unit can allow technicians to see the interactive game room status, including what game is playing, the time remaining, and the ability to access a room control menu. Various embodiments may also allow players to check into the room (they can also do so inside of the room), add players to a team, and choose the game they want to play in the room.

In many embodiments, the interactive game room may also have a CCTV or other camera system by which game technicians can watch what is happening in the room in real-time. In some embodiments, this footage may be captured or otherwise stored for future use and/or sale. Also, the interactive gaming room can be configured to export data on the game in real-time to a “status screen” which can be viewable by external players and/or spectators and also so that game technicians/employees/staff can know that status of games, and know if teams are scoring points or are not scoring points and either they don't understand the game or there is a piece of broken game technology. In certain embodiments, the interactive game room can use the front projection wall to deploy/show “game instructions” prior to each game's commencement. Those instructions can be skipped manually on a USB mini keyboard or other input device by a game technician if needed or by players through an interaction (wristband against the wireless reader, etc.).

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

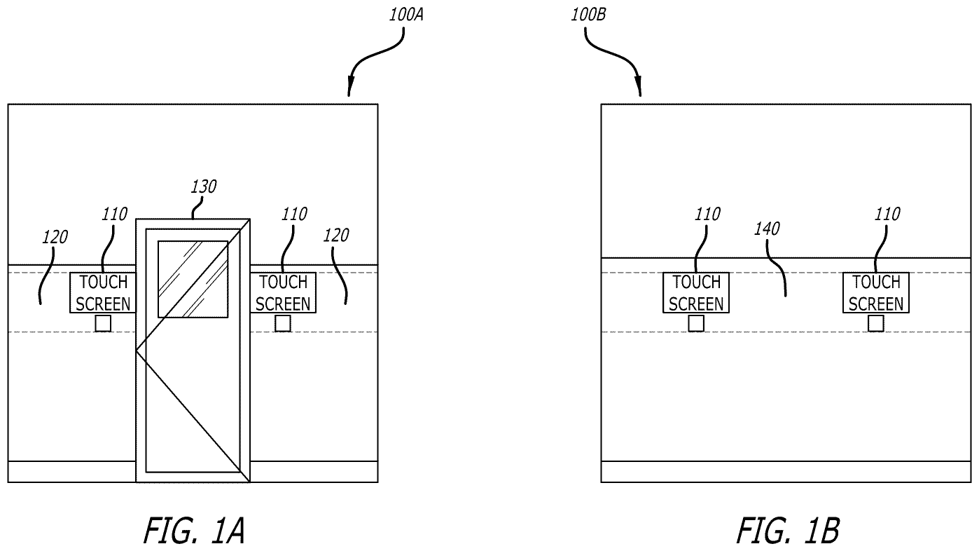

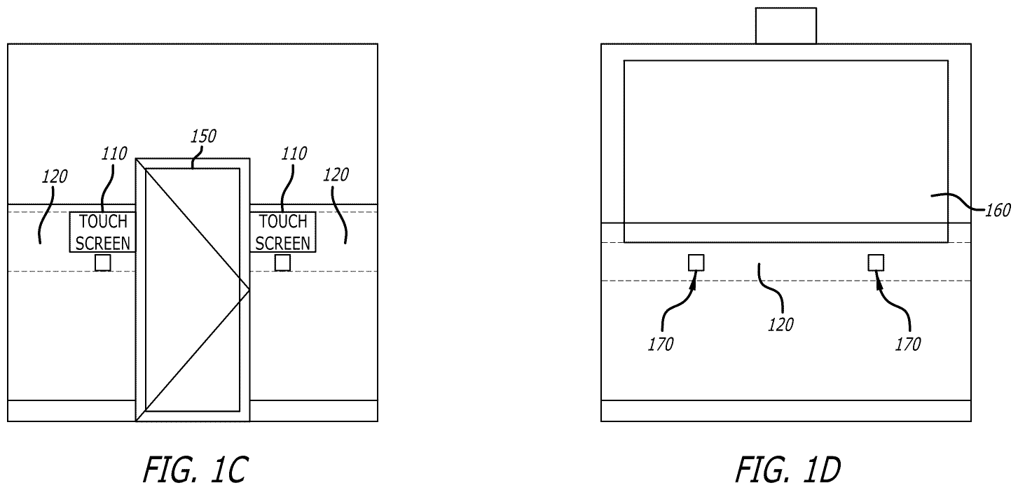

Referring to FIG. 1A, a first wall type 100A for an interactive game room in accordance with various embodiments of the disclosure is shown. In many embodiments, the first wall type 100A can be configured with a doorway 130 that can be for entering and exiting the interactive game room. The doorway 130 can be configured to leave the interactive game room area or to enter into a second interactive game room for setups that have a series of interactive game rooms in series. In more embodiments, the first wall type 100A can include a plurality of interactive game room devices 110, which may be configured as including at least a touch screen display and wireless transceiver, such as those that are configured to interact with wearable devices worn by players.

In additional embodiments, the plurality of interactive game room devices 110 can be positioned within an optimal placement zone 120. Often, the optimal placement zone 120 can be configured to be at a shared eye level or other ideal interactive zone. For example, if players are given wearable wristband devices to interact with the plurality of interactive game room devices 120, the optimal placement zone 120 may be lower to accommodate interactions by lifting an arm up so the wrist can easily be placed on or near the wireless transceiver of the interactive game room devices 120. In another example, if the players are configured with wearable necklaces or lanyards, the optimal placement zone 120 may be higher to allow for easier placement by the players closer to their necks.

In still more embodiments, the optimal placement zone 120 can be dynamically changed based on the average height of the players. For example, if it is known that adults will be play a game next, the optimal placement zone 120 can be set at a first height from the ground. Then, if it is known that younger children will play the next game, the optimal placement zone 120 may be set to a second, lower height from the ground to accommodate them. In some embodiments, the components of the interactive game room, such as the plurality of interactive game room devices 110 can be dynamically adjusted based on the determined optimal placement zone 120 of each player group. However, in certain embodiments, data may be utilized to determine a static optimal placement zone 120 based on the average of known players. In yet further embodiments, the placement of the plurality of interactive game room devices 110 can be equidistant from the outer corner or sides of the first wall type 100A. This can help maintain an equidistant position of each of the plurality of interactive game room devices 110 throughout the interactive game room.

Referring to FIG. 1B, a second wall type 100B for an interactive game room in accordance with various embodiments of the disclosure is shown. Similar to the first wall type 100A, the second wall type 100B can have a plurality of interactive game room devices 110 as well as an optimal placement zone 140. In many embodiments, the optimal placement zone 140 of the second wall type 100B will be at the same height as the optimal placement zones of the other wall types within the interactive game room. The second wall type 100B can be configured without a doorway and can have the plurality of interactive game room devices 110 placed equidistant from the sides or other walls of the interactive game room.

Referring to FIG. 1C, a third wall type 100C for an interactive game room in accordance with various embodiments of the disclosure is shown. Similar to the first wall type 100A, the third wall type 100C can include a doorway 150. However, while the doorway 130 of the first wall type 100A is configured with a door that can be configured to prevent access to the interactive game room, the doorway 150 of the third wall type 100C can be configured without a door such that a passageway exists between the interactive game room and the outside or another interactive game room, such as in arrangements where the interactive game is played in a series of interactive game rooms.

Likewise, a plurality of interactive game room devices 110 can be disposed within an optimal placement zone 120 such that the interactive game room devices 110 are equidistant to the sides or walls of the interactive game room. In some embodiments, the third wall type 100C can be configured with more than two interactive game room devices 110 as depicted in the embodiments shown in FIG. 1C. In these embodiments, each of the plurality of game room devices 110 can be placed equidistant from each other and/or the edges or sides of the walls of the interactive game room.

Referring to FIG. 1D, a fourth wall type 100D for an interactive game room in accordance with various embodiments of the disclosure is shown. In many embodiments, the fourth wall type 100D can be configured with a large screen 160, which can be a projector screen or a self-illuminating screen (i.e., traditional screens). Similar to other wall types, the fourth wall type 100D can have an optimal placement zone 120 where one or more interactive game components may be placed. In the embodiment depicted in FIG. 1D, the fourth wall type 100D includes a pair of wireless transceivers 170 that can be configured to receive signals and otherwise interact with various wearable wireless devices, such as those worn by players. However, it is contemplated that other arrangements and placement of components are possible based on the desired application within the interactive game room.

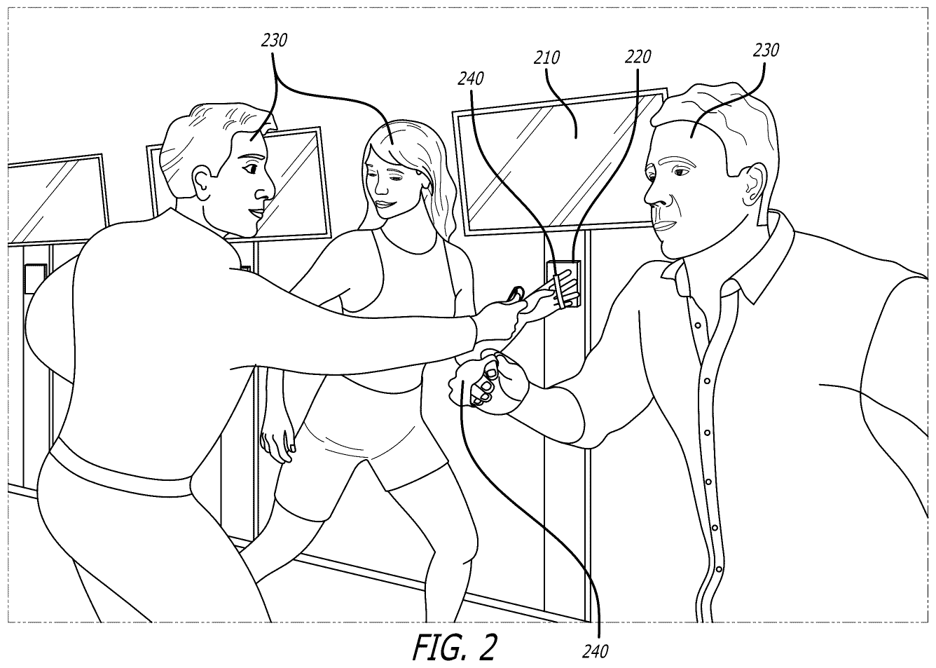

Although a specific embodiment for wall types for an interactive game room suitable for carrying out the various steps, processes, methods, and operations described herein is discussed with respect to FIGS. 1A-1D, any of a variety of systems and/or processes may be utilized in accordance with embodiments of the disclosure. For example, the dimensions can vary based on the location and game types desired, and may include additional shapes such as pentagons, hexagons, octagons and the like. The elements depicted in FIG. 1 may also be interchangeable with other elements of FIGS. 2-9 as required to realize a particularly desired embodiment.

Referring to FIG. 2, a conceptual illustration of a plurality of players 230 engaging in a game with multiple interactive game room devices 200 is shown. In various embodiments, various interactive game rooms can be equipped with a plurality of interactive game room devices, which themselves can comprise a combination display 210 and wireless reader device 220 being utilized during gameplay. In the embodiment depicted in FIG. 2, a plurality of players 230 are playing an interactive game with the combination display 210 and wireless reader device 220. Specifically, each player 230 is associated with a wearable device 240, which can be, but is not limited to, a wireless signal generator, such as a RFID wristband/bracelet/charm which can interact with the wireless reader.

In more embodiments, the display 210 can be configured to indicate one or more game modes or game states. These game states can have game state data associated with it and can be modified based on a change in the game state data triggered by the interaction between the wearable devices 240 and the wireless reader device 220. The game state can be determined by a game logic in communication with the plurality of interactive game room devices 200. In fact, a plurality of combination interactive game room devices can be connected communicatively through a wired or wireless communication connection, such as a wireless signal protocol, ethernet cables, etc.

Although a specific embodiment for a combination display and wireless reader device 220 being utilized during gameplay suitable for carrying out the various steps, processes, methods, and operations described herein is discussed with respect to FIG. 2, any of a variety of systems and/or processes may be utilized in accordance with embodiments of the disclosure. For example, the interactive game room devices 200 can be deployed in a variety of arrangements within one or more interactive game rooms. The elements depicted in FIG. 2 may also be interchangeable with other elements of FIGS. 1 and 3-9 as required to realize a particularly desired embodiment.

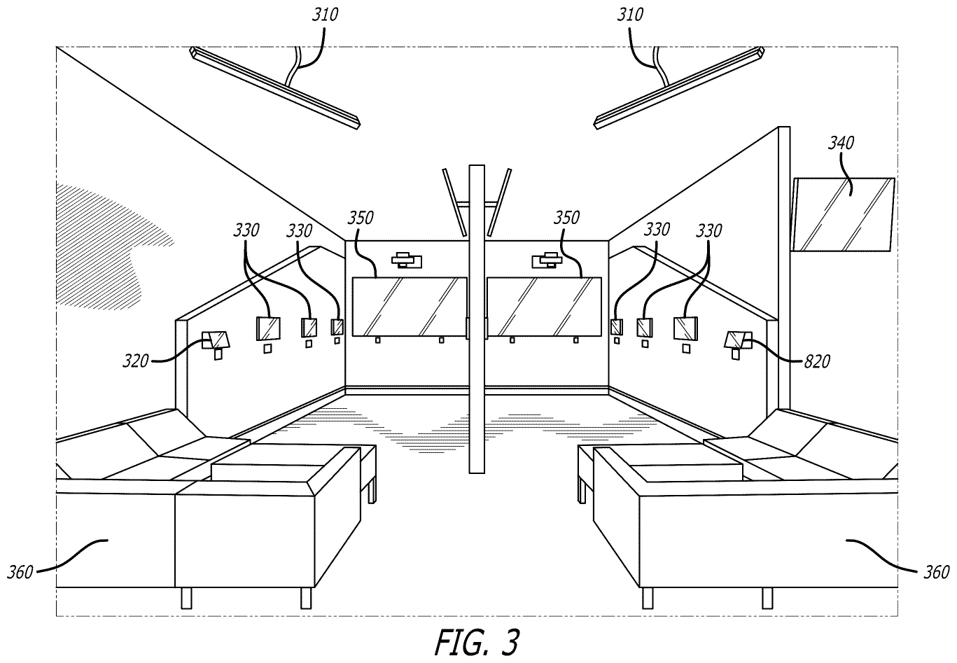

Referring to FIG. 3, a conceptual illustration of a multi-bay interactive game room in accordance with various embodiments of the disclosure is shown. In many embodiments, a plurality of 3-walled bays can be configured into a multi-bay interactive game room arrangement. In the embodiments depicted in FIG. 3, each 3-walled by is configured with a couch 360 for players that are waiting and/or taking a break from the interactive games occurring within the bay. On one end of each 3-walled bay, a large screen 350 can be disposed, which may be a large self-illuminating screen, or may be a projector screen illuminated by a projector device configured within the 3-walled bay.

In additional embodiments, each of the 3-walled bays can be configured with one or more interactive game room devices 330, as well as a check-in device 320. In more embodiments, the check-in device 320 can be a specialized device that may be used for creating a list of players for the current game, selecting players for the next game in the 3-walled bay, or for selecting an interactive game to engage with within the 3-walled bay. Each bay may also be equipped with one or more lighting strips 310 that can be used for general lighting or for lighting in response to an interactive game. In some embodiments, these can include light strips or other illumination devices on the floor or baseboards of the room which can be configured to operate in conjunction with an interactive game occurring in the room. Finally, certain embodiments may include a status monitor 340 positioned outside of the multi-bay interactive game room area. The status monitor 340 can be utilized by players or people outside or not associated with the multi-bay interactive game room to see the current status of the games, past scores, and other data such as, but not limited to, upcoming games, reservations, and players.

One or more interactive games can be initialized and otherwise configured to utilize one or more of the plurality of interactive game room devices 330 within the 3-walled bays. In various embodiments, each of the players can have an associated wireless communication device, like a wristband that can also be utilized within the interactive game. Finally, some embodiments may generate interactive games that utilize multiple 3-walled bay areas or at least two or more bays within the multi-bay interactive game room deployment. This can be in a cooperative or competitive arrangement as desired.

Although a specific embodiment for a multi-bay interactive game room suitable for carrying out the various steps, processes, methods, and operations described herein is discussed with respect to FIG. 3, any of a variety of systems and/or processes may be utilized in accordance with embodiments of the disclosure. For example, the number of bays within these types of interactive game rooms can vary and may depend only on physical limitations such as space or room layouts. The elements depicted in FIG. 3 may also be interchangeable with other elements of FIGS. 1-2 and 4-9 as required to realize a particularly desired embodiment.

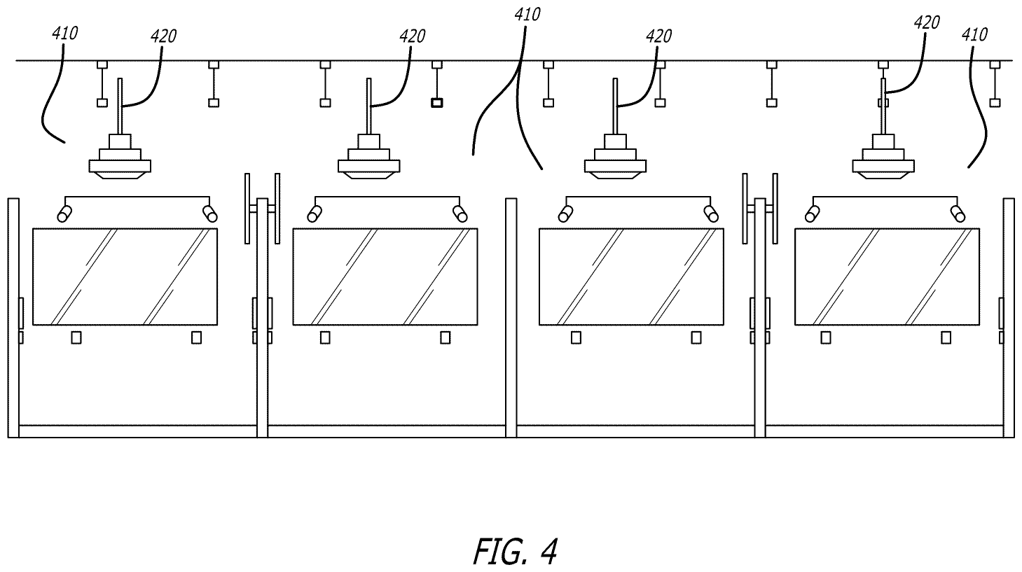

Referring to FIG. 4, a conceptual illustration of a plurality of interactive game rooms 410 in accordance with various embodiments of the disclosure is shown. As previously discussed, an interactive game room can be configured in a variety of ways. The embodiment depicted in FIG. 4 shows a plurality of interactive game rooms 410 that are arranged in a side-by-side layout. Each interactive game room 410 is configured with a large screen that is displayed via a projector 420. However, as those skilled in the art will recognize, a self-illuminating screen may be utilized as desired. Each of the plurality of interactive game rooms 410 can be configured with various elements such as, but not limited to, interactive game room devices, as well as other wireless communication sensors, displays, lights, lasers, smoke machines, etc. In more embodiments, the interactive game rooms 410 can be configured in a cooperative fashion such that an interactive game can have elements occurring in two or more interactive game rooms 410.

In some embodiments, two or more interactive game rooms 410 may be working competitively against another interactive game room 410. In these embodiments, the level or configuration of cooperation vs. competitiveness can be configured based on the current scores, known skill levels/score history of the players, or other factors related to the arrangement of players assigned to the plurality of interactive game rooms 410. In some embodiments, the interactive game rooms 410 can be enclosed as individual rooms with one or more doors configured to access them individually or together, while additionally embodiments can be configured as 3-walled game bays that can be freely traversed between by players depending on the interactive game being played.

Although a specific embodiment for a plurality of interactive game rooms 410 suitable for carrying out the various steps, processes, methods, and operations described herein is discussed with respect to FIG. 4, any of a variety of systems and/or processes may be utilized in accordance with embodiments of the disclosure. For example, the configuration of the interactive game rooms depicted in FIG. 4 may vary based on the available space and may be on opposing sides of a room, etc. The elements depicted in FIG. 4 may also be interchangeable with other elements of FIGS. 1-3 and 5-9 as required to realize a particularly desired embodiment.

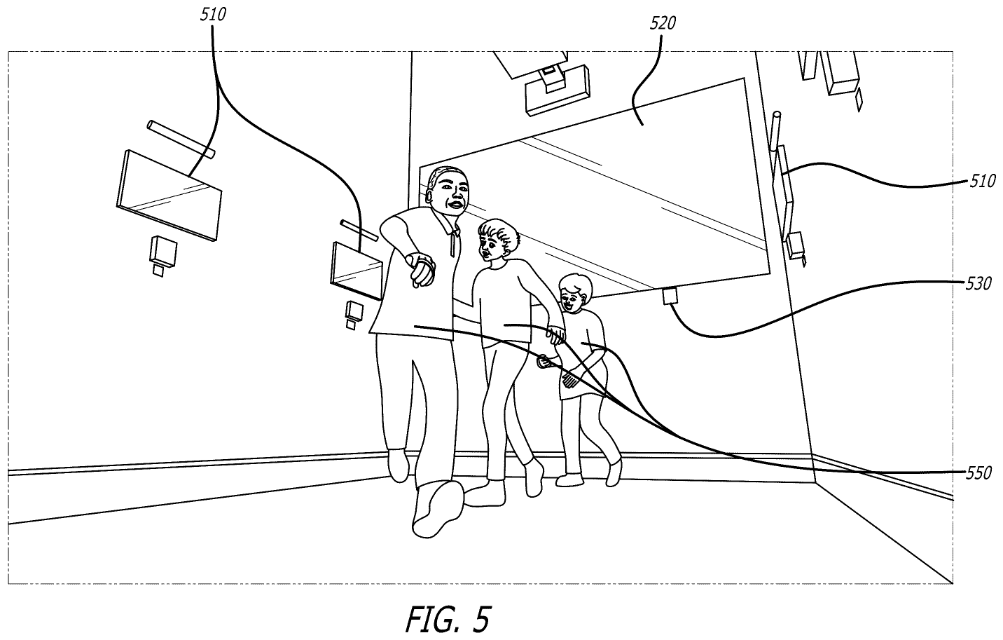

Referring to FIG. 5, a conceptual illustration of a plurality of players 550 utilizing an interactive game room in accordance with various embodiments of the disclosure is shown. As described above, an interactive game room can be configured in a variety of ways to play games. In the embodiment depicted in FIG. 5, a plurality of players 530 are playing an interactive game with multiple interactive game room devices 510 other screens 520, and wireless sensor devices 530. Specifically, each player 550 is associated with a wireless signal generator which can interact with the wireless sensor devices 530 and interactive game room devices 510.

In more embodiments, the players 550 can be associated with identification data which can change based on a change in the game state data. The game state can be determined by a game logic in communication with the interactive game room devices 510 or other game room device. In fact, all of the elements of the interactive game room can be connected communicatively through a wired or wireless communication connection, such as a wireless signal protocol, etc.

Although a specific embodiment for a plurality of players 550 utilizing an interactive game room suitable for carrying out the various steps, processes, methods, and operations described herein is discussed with respect to FIG. 5, any of a variety of systems and/or processes may be utilized in accordance with embodiments of the disclosure. For example, the specific shape, layout, and components utilized within the interactive game room can vary based on the available space provided, the type of game desired, or based on the preferences of the players. The elements depicted in FIG. 5 may also be interchangeable with other elements of FIGS. 1-4 and 6-9 as required to realize a particularly desired embodiment.

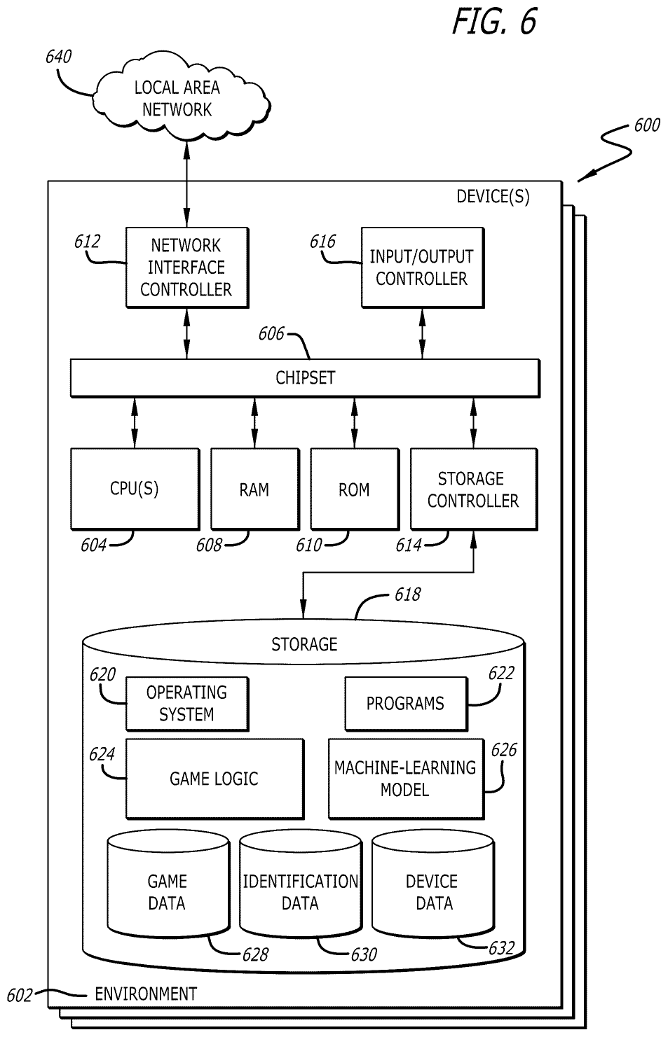

Referring to FIG. 6, a conceptual block diagram of a device 600 suitable for configuration with a game logic 624, in accordance with various embodiments of the disclosure is shown. The embodiment of the conceptual block diagram depicted in FIG. 6 can illustrate a conventional game room device, server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 6 can also illustrate an interactive game room device, wireless sensor device, or other game room deployed computing device in accordance with various embodiments of the disclosure. The device 600 may, in many non-limiting examples, correspond to physical devices or to virtual resources described herein.

In many embodiments, the device 600 may include an environment 602 such as a baseboard or “motherboard,” in physical embodiments that can be configured as a printed circuit board with a multitude of components or devices connected by way of a system bus or other electrical communication paths. Conceptually, in virtualized embodiments, the environment 602 may be a virtual environment that encompasses and executes the remaining components and resources of the device 600. In more embodiments, one or more processors 604, such as, but not limited to, central processing units (“CPUs”) can be configured to operate in conjunction with a chipset 606. The processor(s) 604 can be standard programmable CPUs that perform arithmetic and logical operations necessary for the operation of the device 600.

In a number of embodiments, the processor(s) 604 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 606 may provide an interface between the processor(s) 604 and the remainder of the components and devices within the environment 602. The chipset 606 can provide an interface to a random-access memory (“RAM”) 608, which can be used as the main memory in the device 600 in some embodiments. The chipset 606 can further be configured to provide an interface to a computer-readable storage medium such as a read-only memory (“ROM”) 610 or non-volatile RAM (“NVRAM”) for storing basic routines that can help with various tasks such as, but not limited to, starting up the device 600 and/or transferring information between the various components and devices. The ROM 610 or NVRAM can also store other application components necessary for the operation of the device 600 in accordance with various embodiments described herein.

Additional embodiments of the device 600 can be configured to operate in a networked environment using logical connections to remote computing devices and computer systems through a network, such as the network 640. The chipset 606 can include functionality for providing network connectivity through a network interface card (“NIC”) 612, which may comprise a gigabit Ethernet adapter or similar component. The NIC 612 can be capable of connecting the device 600 to other devices over the network 640. It is contemplated that multiple NICs 612 may be present in the device 600, connecting the device to other types of networks and remote systems.

In further embodiments, the device 600 can be connected to a storage 618 that provides non-volatile storage for data accessible by the device 600. The storage 618 can, for instance, store an operating system 620, applications 622, game data 628, identification data 630, and device data 632 which are described in greater detail below. The storage 618 can be connected to the environment 602 through a storage controller 614 connected to the chipset 606. In certain embodiments, the storage 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 600 can store data within the storage 618 by transforming the physical state of the physical storage units to reflect the information being stored. The specific transformation of physical state can depend on various factors. Examples of such factors can include, but are not limited to, the technology used to implement the physical storage units, whether the storage 618 is characterized as primary or secondary storage, and the like.

In many more embodiments, the device 600 can store information within the storage 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 600 can further read or access information from the storage 618 by detecting the physical states or characteristics of one or more particular locations within the physical storage units.

In addition to the storage 618 described above, the device 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 600. In some examples, the operations performed by a cloud computing network, and or any components included therein, may be supported by one or more devices similar to device 600. Stated otherwise, some or all of the operations performed by the cloud computing network, and or any components included therein, may be performed by one or more devices 600 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 618 can store an operating system 620 utilized to control the operation of the device 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 618 can store other system or application programs and data utilized by the device 600.

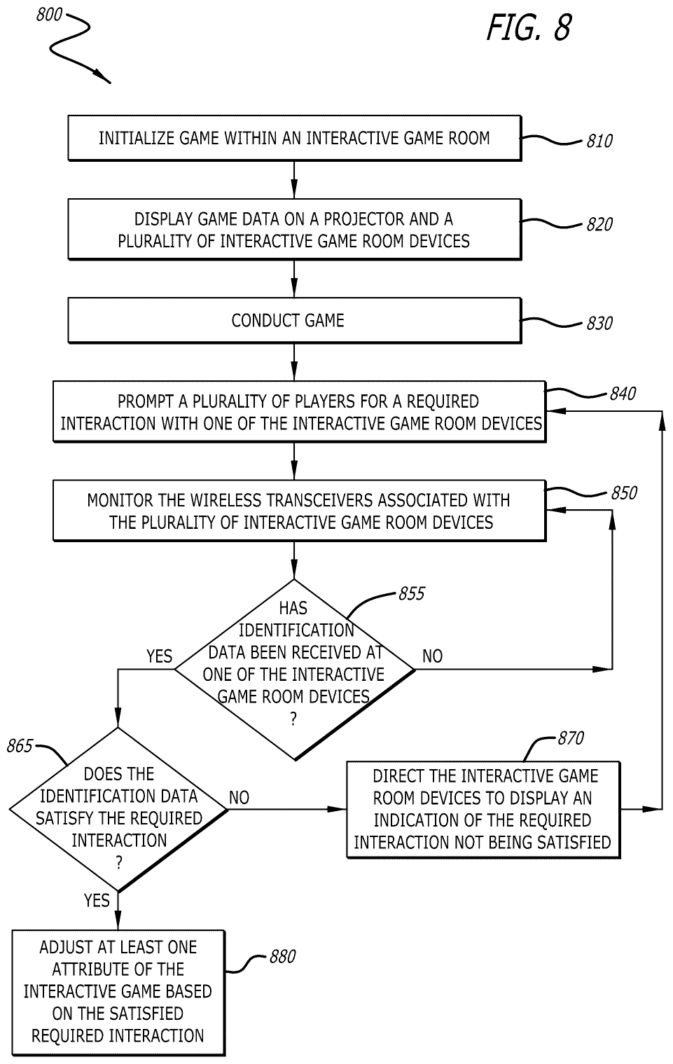

In many additional embodiments, the storage 618 or other computer-readable storage media is encoded with computer-executable instructions which, when loaded into the device 600, may transform it from a general-purpose computing system into a special-purpose computer capable of implementing the embodiments described herein. These computer-executable instructions may be stored as application 622 and transform the device 600 by specifying how the processor(s) 604 can transition between states, as described above. In some embodiments, the device 600 has access to computer-readable storage media storing computer-executable instructions which, when executed by the device 600, perform the various processes described above with regard to FIGS. 1-6 and below in regard to FIGS. 8-10. In certain embodiments, the device 600 can also include computer-readable storage media having instructions stored thereupon for performing any of the other computer-implemented operations described herein.

In many further embodiments, the device 600 may include a game logic 624. The game logic 624 can be configured to perform one or more of the various steps, processes, operations, and/or other methods that are described above. Often, the game logic 624 can be a set of instructions stored within a non-volatile memory that, when executed by the processor(s)/controller(s) 604 can carry out these steps, etc. In some embodiments, the game logic 624 may be a client application that resides on a network-connected device, such as, but not limited to, an interactive game room device, a server, switch, personal or mobile computing device in a single or distributed arrangement. The game logic 624 may receive game data from one or more other devices. The game logic 624 can determine the device parameters associated with the plurality of interactive game room devices within each game room. The game logic 624 may execute a game with a plurality of different players, and update various game modes based on one or more interactions within the game room.

In yet still more embodiments, the device 600 may include game data 628 which may be comprised of various elements essential for defining and managing the gameplay experience. Firstly, game data 628 may include the rules and objectives that outline how the game is to be played, including the specific tasks or challenges players must complete to progress. It can also encompass parameters that determine the game's structure, such as difficulty levels, time limits, and scoring metrics. Additionally, game data 628 may contain detailed information about the game environment, including maps, layouts, and interactive elements that players will encounter.

In some embodiments, game data 628 may also incorporate predefined events and triggers within the plurality of interactive game room devices, which can dictate how the game responds to player actions. For instance, certain player achievements might unlock new levels or activate special features. Game data can also include multimedia components such as graphics, sounds, and animations that enhance the immersive experience, as well as narrative elements that provide context and storyline progression. Moreover, game data 628 can involve configuration settings for the interactive game room devices, ensuring they operate in sync with the game's requirements. This may include the calibration of sensors, displays, and other interactive elements to create a cohesive and responsive environment. In multiplayer scenarios, game data 628 can include coordination protocols for team dynamics, roles, and cooperative tasks, ensuring a balanced and collaborative gameplay experience.

In additional embodiments, the device 600 can also include identification data 630. In a system that utilizes identification data 630 within an interactive game room, this data can be comprised of several components to ensure comprehensive identification and personalized gameplay experiences. Firstly, it may include a unique identifier (UID) assigned to each player's RFID device, such as a bracelet. This UID can be utilized for distinguishing individual players within the game system. Additionally, identification data 630 can encompass user-specific information, including the player's name, profile details, and gaming preferences. This data can also store a player's gaming history, capturing their achievements, skill levels, and any unlocked content or special features relevant to their gameplay. In some embodiments, identification data 630 can incorporate access credentials, determining what areas of the game room(s)/facilities or features the player is authorized to access. In transactional systems, it may include account-related information like balance and recent transactions, or event logs which are another component capable of recording timestamps of player interactions, checkpoints visited, and actions taken during gameplay, which help track and personalize the gaming experience in real-time. In certain embodiments, health and safety information might also be part of the identification data, especially in scenarios where player wellbeing is monitored.

In more embodiments, the device 600 can include device data 632 which may comprise various elements for ensuring the proper functioning and integration of the hardware components with the gameplay experience. In some embodiments, device data can include identification and configuration details for each interactive device in the game room, such as sensors, displays, illumination devices, lasers, projection screens, and other physical devices. This information can ensure that each device is correctly recognized and configured within the system, enabling seamless interaction and communication.

In additional embodiments, device data 632 can encompass the operational status and health metrics of each device, including power levels, connectivity status, and any potential maintenance issues. This can allow the system or a facilities administrator to monitor the performance and reliability of the devices, ensuring they are functioning optimally and addressing any problems promptly. Device data 632 can also include calibration settings, ensuring that sensors and interactive elements are precisely tuned for accurate detection and response to player actions. In further embodiments, device data 632 may comprise real-time interaction logs, capturing how and when each device is used during gameplay. This can include data on player interactions, such as touches, movements, and other inputs detected by the devices, which are essential for creating a responsive and immersive experience. In certain embodiments, the device data 632 can be utilized to determine one or more games or game parameters based on the current makeup of the available devices. For example, if a certain device is not functioning correctly, the device data 632 associated with that device can be utilized to adjust a parameter of the game, such as requiring fewer inputs into the device to score, etc.

In still further embodiments, the device 600 can also include one or more input/output controllers 616 for receiving and processing input from a number of input devices, such as a keyboard, a mouse, a touchpad, a touch screen, an electronic stylus, or other type of input device. Similarly, an input/output controller 616 can be configured to provide output to a display, such as a computer monitor, a flat panel display, a digital projector, a printer, or other type of output device. Those skilled in the art will recognize that the device 600 might not include all of the components shown in FIG. 6 and can include other components that are not explicitly shown in FIG. 6 or might utilize an architecture completely different than that shown in FIG. 6.

As described above, the device 600 may support a virtualization layer, such as one or more virtual resources executing on the device 600. In some examples, the virtualization layer may be supported by a hypervisor that provides one or more virtual machines running on the device 600 to perform functions described herein. The virtualization layer may generally support a virtual resource that performs at least a portion of the techniques described herein.

Finally, in numerous additional embodiments, data may be processed into a format usable by a machine-learning model 626 (e.g., feature vectors), and or other pre-processing techniques. The machine-learning (“ML”) model 626 may be any type of ML model, such as supervised models, reinforcement models, and/or unsupervised models. The ML model 626 may include one or more of linear regression models, logistic regression models, decision trees, Naïve Bayes models, neural networks, k-means cluster models, random forest models, and/or other types of ML models 626.

The ML model(s) 626 can be configured to generate inferences to make predictions or draw conclusions from data. An inference can be considered the output of a process of applying a model to new data. This can occur by learning from at least the game data 628, the identification data 630, and the device data 632 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 626 may be generated by human/administrator verifications or may compare predicted outcomes with actual outcomes.

In certain embodiments, ML models 626 could analyze the identification data 630 from players, learning their preferences, behavior patterns, and skill levels over time. By processing this data, the ML models 626 can personalize game modes, dynamically adjusting difficulty levels and content to match the player's abilities and interests, thereby providing a tailored gaming experience that evolves as the player progresses. In further embodiments, ML models 626 could be used to predict player actions and preferences, enabling the game system to proactively adapt the environment and challenges. For example, if a model identifies that a player frequently struggles with a particular type of puzzle, it can adjust future puzzles to be more accessible or provide additional hints, enhancing player engagement and satisfaction. These models can also optimize game flow and pacing, ensuring that players remain challenged but not frustrated, by balancing the introduction of new tasks and rewards based on their progress and performance.

In multiplayer scenarios, ML models 626 can be configured to analyze team dynamics and individual contributions, helping to balance teams and assign roles that maximize cooperation and effectiveness. They can identify patterns in how players interact and collaborate, using this information to create more cohesive and enjoyable team experiences. Additionally, machine learning models can monitor device data 632, predicting maintenance needs and preventing downtime by identifying patterns that indicate potential hardware failures before they occur. ML models 626 may also enhance security by detecting unusual patterns of behavior that may indicate unauthorized access or cheating, thereby ensuring a fair and secure gaming environment.

Although a specific embodiment for a conceptual block diagram of a device suitable for configuration with a game logic suitable for carrying out the various steps, processes, methods, and operations described herein is discussed with respect to FIG. 6, any of a variety of systems and/or processes may be utilized in accordance with embodiments of the disclosure. For example, the device 600 may be in a virtual environment such as a cloud-based network suite, or it may be distributed across a variety of game devices or game room systems. The elements depicted in FIG. 6 may also be interchangeable with other elements of FIGS. 1-5 and 7-9 as required to realize a particularly desired embodiment.

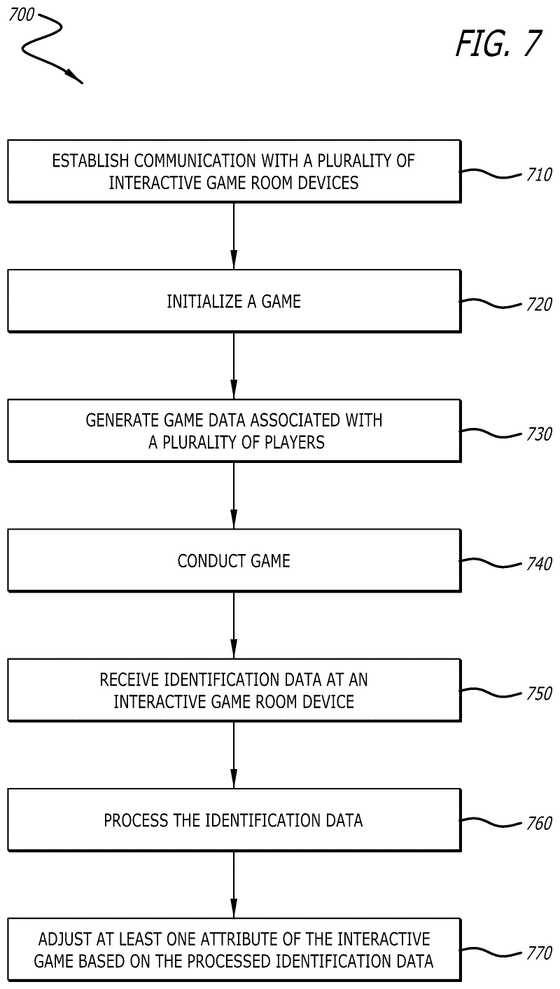

Referring to FIG. 7, a flowchart depicting a process 700 for executing a game within an interactive game room in accordance with various embodiments of the disclosure is shown. In many embodiments, the process 700 can establish communication with a plurality of interactive game room devices (block 710). In some embodiments, the communication can be established by utilizing a centralized control system, such as for example, the device depicted in FIG. 6, that coordinates the connectivity and data exchange between each device. This may include initializing a network protocol that supports multiple device types, such as sensors, displays, VR headsets, and/or interactive props, ensuring they are all connected to a common platform. The control system may assign unique identifiers to each device, enabling the process to recognize and communicate with them individually. Once the devices are registered, the process can continuously monitor their status and operational health, using real-time data transmission to maintain an active connection. This may occur using standard communication protocols, such as Wi-Fi, Bluetooth, or other wireless technologies, to facilitate seamless data flow between devices and the central control unit.

In a number of embodiments, the process 700 can initialize a game (block 720). In some embodiments, the process 700 might initialize an interactive game by first receiving and verifying the necessary game data and identification data from players as they enter the interactive game room. This may begin by authenticating each player's RFID device, such as a bracelet, using wireless sensors positioned throughout the room to ensure the correct players are present and properly registered. Once authentication is complete, the process 700 can load the game data, which includes the rules, objectives, and configuration settings specific to the chosen game mode. In various embodiments, the process 700 can activate the relevant interactive devices, such as screens, sensors, and audio systems, calibrating them to align with the game's requirements. Communication may be established between all devices to ensure synchronized operation and prepare the game environment by setting up the initial conditions, such as displaying the introductory narrative, setting timers, or enabling specific interactive elements. Additionally, in some embodiments, the process 700 might access machine learning models to customize the game's difficulty and challenges based on the players' previous performance and preferences, providing a personalized experience from the outset.

In more embodiments, the process 700 can generate game data associated with a plurality of players (block 730). In certain embodiments, the process 700 can initialize an interactive game by first receiving and verifying the necessary game data and identification data from players as they enter the interactive game room. Once authentication is complete, the process 700 can load the game data, which includes the rules, objectives, and configuration settings specific to the chosen game mode.

In additional embodiments, the process 700 can conduct a game (block 740). As those skilled in the art will recognize, in an interactive game room, a wide variety of games can be played, leveraging the room's advanced technology and dynamic environment to create engaging experiences. These games might include escape room-style puzzles, where players must solve riddles, decipher codes, and find hidden clues within a set time to “escape” or achieve a specific goal. Virtual reality (VR) or augmented reality (AR) games can immerse players in fantastical worlds or realistic simulations, allowing them to interact with digital elements overlaid on the physical space. Team-based games, such as competitive scavenger hunts or tactical challenges, encourage collaboration and strategic thinking, with players working together to complete tasks or outmaneuver opposing teams. Physical activity games might use motion sensors to track players' movements, requiring them to dodge obstacles, mimic dance moves, or complete physical challenges. Role-playing games could also be played, where players assume different characters and make decisions that influence the storyline, guided by interactive displays and narrative prompts. Overall, the diverse range of games that can be played in an interactive game room utilizes the technology to create unique, immersive, and personalized experiences for players of all ages and interests.

In further embodiments, the process 700 can receive identification data at an interactive game room device (block 750). In various embodiments, identification data can typically be gathered through wireless sensors, such as RFID devices such as wristbands or cards, uniquely identifies each participant and is used to access their personal profiles, game history, and preferences stored within the game system. When a player interacts with an interactive game room device, the device can read the identification data to determine the player's identity and tailor the game content accordingly. The identification data could be physically received by the interactive game room device through a wireless communication method, such as RFID or NFC technology, where the player's RFID-enabled wristband or card is scanned by a sensor embedded in the device. Upon proximity or contact, the sensor can read the unique identifier from the wristband, allowing the device to access and process the relevant player information stored in the system.

In still more embodiments, the process 700 can process the identification data (block 760). In various embodiments, upon being received by the interactive game room device, it is processed by a central controller or game logic to verify and authenticate the player's identity. The unique identifier from the RFID-enabled wristband or card can be matched against a database of registered players, retrieving the corresponding profile, which includes personal information, game preferences, and past performance. The system may then use this data to determine the appropriate game settings and content for the player, such as adjusting difficulty levels, unlocking specific challenges, or personalizing feedback based on their previous interactions and achievements. This processing also ensures that the player is authorized to access certain areas or features within the game room, enforcing security protocols and maintaining a controlled environment. Furthermore, the system continuously updates the player's profile in real-time as they interact with different game elements, capturing new data to refine future gameplay experiences and provide a tailored, dynamic gaming environment.

In yet additional embodiments, the process 700 can adjust at least one attribute of the interactive game based on the processed identification data (block 770). In response to the processed identification data, one or more attributes of the interactive game room may be adjusted to tailor the gameplay to the specific player. These attributes may include the difficulty level of challenges, which can be increased or decreased based on the player's skill level and past performance, ensuring an appropriate level of challenge and engagement. The game narrative or storyline may also be personalized, with different paths or scenarios unfolding depending on the player's previous choices and progress. Additionally, the timing and pace of gameplay can be modified, such as extending or shortening time limits for tasks or adjusting the speed of moving elements to match the player's ability. In some embodiments, the system may unlock or restrict access to certain areas, tools, or game features, granting special privileges or maintaining security based on the player's profile and authorization level. Rewards and feedback mechanisms, such as points, badges, or in-game items, can also be customized to provide motivation and recognition aligned with the player's achievements and preferences. These dynamic adjustments enhance the overall gaming experience, making it more engaging, personalized, and challenging for each participant.

Although a specific embodiment for a side view of a first wall and a second wall of a 4-walled interactive game room suitable for carrying out the various steps, processes, methods, and operations described herein is discussed with respect to FIG. 7, any of a variety of systems and/or processes may be utilized in accordance with embodiments of the disclosure. For example, the size of the room can vary in size, but can be ten feet in width for each wall to create a square interactive game room for example. The elements depicted in FIG. 7 may also be interchangeable with other elements of FIGS. 1-6 and 8-9 as required to realize a particularly desired embodiment.

Referring to FIG. 8, a flowchart depicting a process 800 for utilizing an interactive game room device within the interactive game room in accordance with various embodiments of the disclosure is shown. In many embodiments, the process 800 can initialize a game within an interactive game room (block 810). In some embodiments, the process 800 might initialize an interactive game by first receiving and verifying the necessary game data and identification data from players as they enter the interactive game room. This may begin by authenticating each player's RFID device, such as a bracelet, using wireless sensors positioned throughout the room to ensure the correct players are present and properly registered. Once authentication is complete, the process 800 can load the game data, which includes the rules, objectives, and configuration settings specific to the chosen game mode. In various embodiments, the process 800 can activate the relevant interactive devices, such as screens, sensors, and audio systems, calibrating them to align with the game's requirements. Communication may be established between all devices to ensure synchronized operation and prepare the game environment by setting up the initial conditions, such as displaying the introductory narrative, setting timers, or enabling specific interactive elements. Additionally, in some embodiments, the process 800 might access machine learning models to customize the game's difficulty and challenges based on the players' previous performance and preferences, providing a personalized experience from the outset.

In a number of embodiments, the process 800 can display game data on a projector and a plurality of interactive game room devices (block 820). Within an interactive game room, a projector, large screen, or interactive device can display a variety of data designed to enhance player engagement and guide gameplay. This data may include real-time game information, such as current objectives, time remaining, scores, and player rankings, providing immediate feedback and keeping players informed about their progress. Visual cues and animations can indicate player achievements, like unlocking new levels or earning rewards, creating a sense of accomplishment. Interactive elements, such as virtual buttons, maps, or clues, may be displayed to encourage direct player interaction and decision-making. In multiplayer scenarios, the screen can show team statistics, collaborative goals, and dynamic prompts to facilitate coordination and communication among players. Additionally, narrative content, such as storyline developments, character dialogues, or immersive environments, can be projected to deepen the thematic experience and keep players immersed in the game world.

In more embodiments, the process 800 can conduct the game (block 830). As those skilled in the art will recognize, in an interactive game room, a wide variety of games can be played, leveraging the room's advanced technology and dynamic environment to create engaging experiences. These games might include escape room-style puzzles, where players must solve riddles, decipher codes, and find hidden clues within a set time to “escape” or achieve a specific goal. Virtual reality (VR) or augmented reality (AR) games can immerse players in fantastical worlds or realistic simulations, allowing them to interact with digital elements overlaid on the physical space. Team-based games, such as competitive scavenger hunts or tactical challenges, encourage collaboration and strategic thinking, with players working together to complete tasks or outmaneuver opposing teams. Physical activity games might use motion sensors to track players' movements, requiring them to dodge obstacles, mimic dance moves, or complete physical challenges. Role-playing games could also be played, where players assume different characters and make decisions that influence the storyline, guided by interactive displays and narrative prompts. Overall, the diverse range of games that can be played in an interactive game room utilizes the technology to create unique, immersive, and personalized experiences for players of all ages and interests.

In additional embodiments, the process 800 can prompt a plurality of players for a required interaction with one of the interactive game room devices (block 840). In various embodiments, an interactive game executed by the process 800 may prompt a player for a required interaction with one of the game room devices to advance the storyline, complete a challenge, or unlock new game elements. The prompt may be triggered based on the processed identification data and game logic, which identifies when a player reaches a specific point in the game where action is necessary. The data needed to display the prompt may include the player's current location, progress, and the specific task or challenge at hand. This data can be used to generate a context-specific message or visual cue that guides the player on what action to take next. For example, if a player needs to scan their RFID wristband at a checkpoint or interact with a digital puzzle on a touchscreen, the system can display a clear, concise prompt on a large screen, projector, or directly on the interactive device itself. This prompt could be shown as a flashing icon, text message, or animated sequence, often accompanied by sound effects or voice instructions to draw the player's attention and ensure they understand the required interaction.

In further embodiments, the process 800 can monitor the wireless transceivers associated with the plurality of interactive game room devices (block 850). In some embodiments, the wireless transceivers associated with the interactive game room can be configured to continuously monitor for activity by detecting signals from players' RFID-enabled devices, such as wristbands or cards, as they move within the game environment. These transceivers, strategically placed throughout the room, can scan for the presence and proximity of RFID signals, allowing the system to determine the location and movements of each player in real-time. When a player approaches or interacts with a specific game element or device, the transceivers detect the RFID signal and relay this information to the central game control system. This may enable the system to verify if the required interaction, prompted earlier, has been initiated or completed by the player. Additionally, the transceivers can monitor multiple players simultaneously, identifying when and where each player is active, which is crucial for games that require coordination or competition between teams.

In some embodiments, the process 800 can determine if identification data been received at one of the interactive game room devices (block 855). In some embodiments, to determine if identification data has been received at one of the interactive game room devices, the process 800 can employ a combination of wireless communication protocols and signal processing techniques. For example, each interactive device, equipped with an RFID reader or a similar wireless transceiver, continuously emits low-power radio frequency signals to create a detection field. When an RFID-enabled device, such as a player's wristband or card, enters this detection field, it responds by transmitting its unique identification data back to the reader. The interactive game room device then captures this incoming signal and decodes the RFID tag's unique identifier using integrated firmware or software protocols. The decoded identification data can be immediately sent to the central game control system or logic where it is cross-referenced against a database of registered players. If it is determined that no identification data has been received, then the process 800 can continue to monitor the wireless transceivers associated with the plurality of interactive game room devices (block 840).

However, if it is determined that identification data has been received, then various embodiments of the process 800 can determine if the identification data satisfies a required interaction (block 865). The system checks for data integrity and authenticity to ensure the signal corresponds to a legitimate, authorized player. If the identification data matches an entry in the database, a successful reception is logged, and the game logic can proceed to adjust the game state or trigger the next interactive sequence, confirming that the identification data has been accurately received and processed. In various embodiments, the process 800 can determine if the received identification data satisfies the required interaction by cross-referencing the data with a predefined list of expected inputs or actions stored in the system's database, ensuring it matches the specific criteria for the current game state or task.

If it is determined that the identification data does not satisfy the required interaction, some embodiments of the process 800 can direct the interactive game room devices to display an indication of the required interaction not being satisfied (block 870). In certain embodiments, the process 800 can recognize the mismatch and flag it as an incomplete or incorrect action. As a result, the game logic can generate a prompt within the interactive game room, displayed on a screen or device, to inform the player of the incorrect interaction and guide them toward the correct action needed. This prompt may include visual cues, text instructions, or audio alerts, directing the player to retry or move to a different location to complete the task properly.

However, if it is determined that the identification data does satisfy the required interaction, then various embodiments of the process 800 can adjust at least one attribute of the interactive game based on the satisfied required interaction (block 880). In some embodiments, if the identification data corresponds to the correct player and fulfills the conditions set for the interaction—such as scanning at the right location or completing a designated action—the system registers the interaction as valid and allows the game to progress. In more embodiments, the process 800 can confirm that the correct action has been completed and registers the interaction as valid. As a result, the game logic updates the game state and may generate a prompt or visual feedback within the interactive game room to acknowledge the player's successful action, such as displaying a congratulatory message or unlocking the next level. This positive reinforcement encourages the player to continue progressing through the game, maintaining engagement and flow.

Although a specific embodiment for a side view of a third wall and a fourth wall of a 4-walled interactive game room suitable for carrying out the various steps, processes, methods, and operations described herein is discussed with respect to FIG. 8, any of a variety of systems and/or processes may be utilized in accordance with embodiments of the disclosure. For example, the interactive game room can include a plurality of various elements to enhance or facilitate gameplay such as, but not limited to, a plurality of illumination devices on the floor, such as light-emitting diodes that can be changed in response to a change in game state executed by a game logic or atmospheric elements like smoke, artificial smells, or sounds. The elements depicted in FIG. 8 may also be interchangeable with other elements of FIGS. 1-7 and 9 as required to realize a particularly desired embodiment.

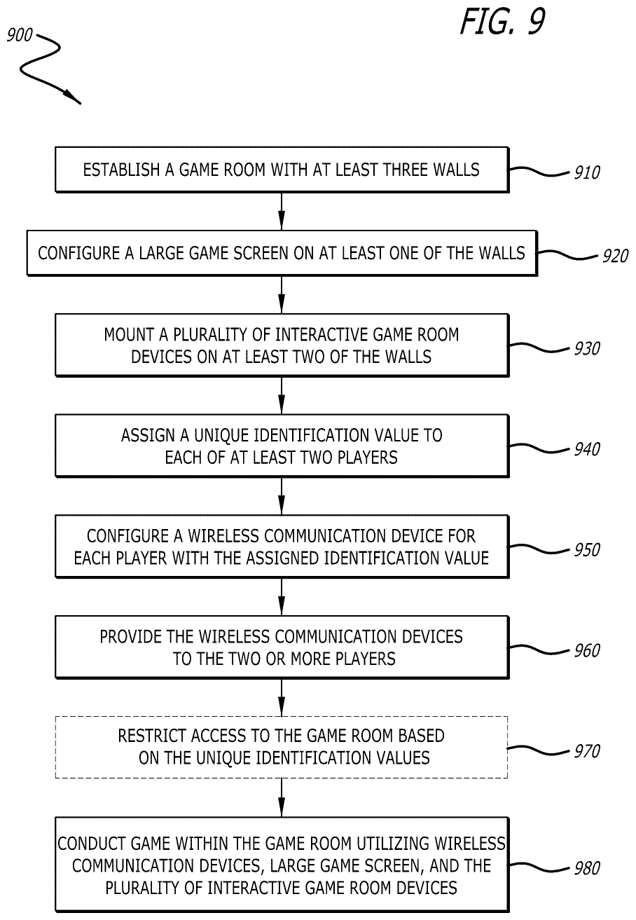

Referring to FIG. 9, a flowchart depicting a process 900 for executing a game within a multi-bay interactive game room in accordance with various embodiments of the disclosure is shown. In many embodiments, the process 900 can establish an interactive game room with at least three walls (block 910). In various embodiments, the process 900 can dedicate each wall to a different type of gaming experience or plurality of game room components to create a dynamic and engaging environment.

In a number of embodiments, the process 900 can configure a large game screen on at least one of the walls (block 920). In many embodiments, the optimal placement of the screen on the wall can be determined to ensure visibility for all players; involving considering the room layout and potential viewing angles. In some embodiments, various settings, such as, but not limited to, brightness, contrast, and resolution can be set according to the room's lighting conditions, ensuring clear visibility without glare or eye strain. In more embodiments, the process 900 can direct the screen to display dynamic content, such as player scores, game objectives, or interactive prompts, which may be updated based on inputs from wireless transceivers and sensors that track player movements and interactions.

In more embodiments, the process 900 can mount a plurality of interactive game room devices on at least two of the walls (block 930). The mounting can be done dynamically, or in response to the type of game that will be played within the interactive game room. For example, one wall could feature a large flat-screen TV or projector while the other walls can be equipped with a plurality of interactive game room devices. To enhance the immersive experience, additional elements can be added such as, but not limited to, LED lighting, wall-mounted speakers for surround sound, and themed decor related to your favorite games. This setup can diversify the gaming options and ensure that the room caters to different types of players and preferences.

In additional embodiments, the process 900 can assign a unique identification value to each of at least two players (block 940). In some embodiments, the process 900 can assign a unique identification value to each of at least two players by utilizing an automated registration system integrated with RFID technology. For example, when players enter the interactive game room, they are each provided with an RFID-enabled device, such as a wristband or card, that contains a built-in microchip capable of storing data. During the registration phase, the system can assign a unique identification value—such as a specific alphanumeric code or number—to each RFID device, ensuring that no two players share the same identifier. This unique value can then be stored in both the RFID device and the central game control system's database, linking it to the individual player's profile. As players interact with the game room devices, wireless sensors read the RFID data, allowing the system to accurately track their movements and interactions based on their unique identification values. As such, the process 900 can therefore configure a wireless communication device for each player with the assigned identification value in various embodiments (block 950).

In still more embodiments, the process 900 can provide the wireless communication devices to the two or more players (block 960). However, it is contemplated that any number of players may be playing. The providing of the wireless device may be done prior to the start of the game, such as during a setup or registration phase. However, some embodiments may deliver the wireless communication devices during gameplay after one or more events.

In certain embodiments, the process 900 can restrict access to the interactive game room based on the unique identification values (block 970). In certain embodiments, upon arrival, each player can be required to scan their RFID-enabled device, such as a wristband or card, at a checkpoint or entry terminal equipped with an RFID reader. The system reads the unique identification value encoded in the RFID device and cross-references it with a database of authorized players to verify their access level. If the identification value matches an entry in the authorized list and meets the criteria for access—such as membership status, age restrictions, or specific game participation—the player can be granted entry. However, if the identification value is not recognized or does not meet the required criteria, the system may deny access and triggers a notification on a display or alert system. Additionally, the system can implement tiered access levels, where certain areas or game modes within the room are only accessible to players with specific identification values, ensuring that access is controlled and tailored according to predefined rules and player profiles. This approach not only enhances security but also helps manage player flow and ensure a safe, organized, and personalized experience.

In yet additional embodiments, the process 900 can conduct a game within the interactive game room utilizing wireless communication devices, large game screen, and the plurality of interactive game room devices (block 980). In various embodiments, the process 900 can begin by using wireless communication devices, such as RFID readers and sensors, to detect players' presence and track their movements and actions in real-time. This data can be transmitted wirelessly to the central game control system, which processes the information and dynamically adjusts the game state based on player interactions. The large game screen can serve as a central hub for displaying key game information, such as objectives, scores, and real-time updates, as well as providing visual and audio feedback that guides players throughout the game. Interactive game room devices, such as touchscreens, motion sensors, and VR headsets, can be synchronized with the game logic to respond to players' actions, triggering specific events, challenges, or narrative developments based on the game's progress.

Although a specific embodiment for a player utilizing the four-walled interactive game room suitable for carrying out the various steps, processes, methods, and operations described herein is discussed with respect to FIG. 9, any of a variety of systems and/or processes may be utilized in accordance with embodiments of the disclosure. For example, the elements depicted in FIG. 9 may also be interchangeable with other elements of FIGS. 1-8 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. An interactive game bay, comprising:
a processor;
a plurality of interactive game bay devices;
a projector configured to display images related to an interactive game;
a memory communicatively coupled to the processor, wherein the memory comprises a game bay logic configured to:
establish communication with the plurality of interactive game bay devices;
initialize the interactive game, wherein the interactive game is configured to utilize the plurality of interactive game bay devices and projector; <generate game data associated with a plurality of players, wherein:
each of the plurality of players is associated with a wireless communication device; and
each wireless communication device is configured to transmit identification data;
receive identification data via at least one of the interactive game bay devices;
process the identification data; and
adjust at least one attribute of the interactive game in response to the processed identification data.

2. The interactive game bay of claim 1, wherein each of the plurality of interactive game bay devices comprises at least a display and a wireless transceiver unit.

3. The interactive game bay of claim 2, wherein the identification data is transmitted to the wireless transceiver unit

4. The interactive game bay of claim 3, wherein the wireless transceiver unit is a radio frequency identification (RFID) transceiver.

5. The interactive game bay of claim 1, wherein the game bay logic is further configured to direct the projector to indicate the adjustment of the at least one attribute.

6. The interactive game bay of claim 1, wherein the game bay logic is further configured to direct the at least one of the plurality of interactive game bay devices to indicate the adjustment of the at least one attribute.

7. The interactive game bay of claim 1, wherein the interactive game bay further comprises four walls, wherein two of the walls are configured with at least one interactive game bay device.

8. The interactive game bay of claim 7, wherein at least one of the walls is configured with a screen configured to receive images displayed by the projector.

9. The interactive game bay of claim 8, wherein at least one of the walls is configured with a doorway for entering the interactive game bay.

10. The interactive game by of claim 9, wherein at least one of the walls is configured with a doorway for entering a second interactive game bay.

11. The interactive game bay of claim 1, wherein the interactive game bay further comprises three walls, wherein one of the walls are configured with at least two interactive game bay devices.

12. The interactive game bay of claim 11, wherein at least one of the walls is configured with a screen configured to receive images displayed by the projector.

13. The interactive game bay of claim 12, wherein one wall is a shared wall with a second interactive game bay.

14. The interactive game bay of claim 1, wherein processing the identification data comprises comparing at least a portion of the identification data against a player value associated with the interactive game.

15. The interactive game bay of claim 14, wherein the player value is associated with a specific player.

16. The interactive game bay of claim 14, wherein the attribute of the interactive game is associated to whether a certain player interacted with at least one of the plurality of interactive game bay devices.

17. An interactive game bay, comprising:
at least three walls;
a plurality of interactive game bay devices wherein each of the plurality of interactive game bay devices are mounted at the same height relative to a floor on at least one of the three walls;
a projector configured to display images related to an interactive game on at least one of the three walls;
an interactive gaming device, comprising:
a processor;
a memory communicatively coupled to the processor, wherein the memory comprises a game bay logic configured to:
establish communication with the plurality of interactive game bay devices;
initialize the interactive game, wherein the interactive game is configured to utilize the plurality of interactive game bay devices and projector;
generate game data associated with a plurality of players, wherein:
each of the plurality of players is associated with a wireless communication device; and
each wireless communication device is configured to transmit unique identification data;
receive identification data via at least one of the interactive game bay devices;
process the identification data; and
adjust at least one attribute of the interactive game in response to the processed identification data.

18. The interactive game bay of claim 17, wherein the interactive game bay comprises four walls and the plurality of interactive game bay devices are mounted on at least two of the four walls.

19. The interactive game bay of claim 17, wherein the unique identification data is assigned to a specific player of the plurality of players.

20. A method of conducting an interactive game within an interactive game room, comprising:
establishing communication with a plurality of interactive game bay devices and a projector;
initializing the interactive game, wherein the interactive game is configured to utilize the plurality of interactive game bay devices and projector;
generating game data associated with a plurality of players, wherein:
each of the plurality of players is associated with a wireless communication device; and
each wireless communication device is configured to transmit identification data;
receiving identification data via at least one of the interactive game bay devices;
processing the identification data; and
adjusting at least one attribute of the interactive game in response to the processed identification data.
